(19) United States
(12) Patent Application Publication
(10) Pub. No.: US 2004/0204073 A1
(43) Pub. Date: Oct. 14, 2004

(54) Network technology augmented user device framework

(75) Inventor: John Anthony Yanosy, Grapevine, TX (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/146,557

(22) Filed: May 15, 2002

(51) Int. Cl. H04B 1/38

(52) U.S. Cl. 455/557; 455/556.1

(57) ABSTRACT

A mobile device (10) includes a microprocessor (100), a device profile (101) stored in a local memory (102), a device application (103) and a virtual operating system (104). A sharable resources computer network (12) includes a plurality of servers or computer hosts (125), a virtual service provider (121) and sharable resources (122). The virtual service provider includes a broker (123) and a mediator (124). In operation, the mobile device application (103) requests device augmentation. The request is forwarded from the virtual operating system (104) to the broker (123). The broker (123) determines an appropriate sharable resource by comparing the device profile (101) with a directory of sharable resources stored in a knowledge base (126). The mediator (124) coordinates the specific access to the sharable resource with the device application (103). The device application (103) can specify sharable resources by providing an application program interface.

### BACKGROUND OF THE INVENTION

1. Field of the Invention

The present invention relates to mobile devices and computer networks, and, more particularly, to a computer network with sharable resources for a mobile device to utilize.

2. Description of the Related Art

Conventional mobile devices, such as mobile phones, are growing in features, functions, and capabilities. In the near future, such mobile devices are expected to be able to host limited application software functions that may run locally or interactively with network applications. However, conventional mobile devices have static capabilities for processing applications and storing files. As a result, the mobile device cannot process applications if they lack the proper application processing capabilities or store files if they exceed their respective local memory capacities.

Such a situation often arises when a user of a mobile device receives a file from a remote user in a specific format, such as MPEG Audio Layer 3 (MP3), and the mobile device does not have MP3 application processing capability. In this situation, the mobile device user must augment the application processing capabilities of the mobile device to enable it to process the MP3 file. However, such a task is extremely difficult for the common user because of the static nature of conventional mobile devices. For example, in order to augment the static application processing capabilities, the user must replace a local electronics card in the mobile device with a new electronics card that has the new processing capabilities, or must obtain a client device that can adapt the content of an incoming file to meet the processing capabilities of the user's mobile device.

As technology continues to evolve, and more application platforms are developed, users of these conventional mobile devices will be even more limited in their ability to adequately process applications. Therefore, what is needed is a method and apparatus for dynamically augmenting the capabilities of a mobile device.

### BRIEF DESCRIPTION OF THE DRAWINGS

Objects and advantages of the present invention will be more readily apparent from the following detailed description of preferred embodiments thereof when taken together with the accompanying drawings in which:

FIG. 1 is a diagram of an exemplary environment in which various embodiments according to the present invention may be implemented;

FIG. 2 is a block diagram of the hardware and software components of a preferred embodiment of a mobile device of FIG. 1 according to the present invention;

FIG. 3 is an exemplary mobile device profile according to the present invention;

FIG. 4 is an exemplary virtual operating system profile according to the present invention;

FIG. 5 is an exemplary request profile in which a proxy is associated with the mobile device profile according to the present invention;

FIG. 6 is an exemplary profile in a resource description framework illustrating the encoding for the links between the mobile device local profile, request profile and proxy profile according to the present invention;

FIG. 7 is an exemplary profile in a resource description framework illustrating the encoding for the links between the mobile device local profile and multiple proxies according to the present invention;

FIG. 8 is an exemplary proxy profile according to the present invention;

FIG. 9-FIG. 10 is an exemplary profile illustrating the encoding for the links between the mobile device profile, proxy profile and sharable resource profile according to the present invention;

FIG. 11 is a flow diagram illustrating operation of the mobile device in selecting device augmentation services according to the present invention;

FIG. 12 is an exemplary sharable resources network for providing device augmentation according to the present invention;

FIG. 13 is a diagram of the functional tasks performed by the sharable resources network of FIG. 11 in providing device augmentation according to the present invention;

FIG. 14 is a diagram illustrating the major functions of the framework according to the present invention.

FIG. 15 is a sequence diagram illustrating a selection of mobile device preferences by the mobile device of FIG. 2 according to the present invention; and

FIG. 16 is a sequence diagram for an exemplary case where the mobile device of FIG. 1 utilizes a sharable resource according to the present invention.

### BRIEF DESCRIPTION OF THE PREFERRED EMBODIMENTS

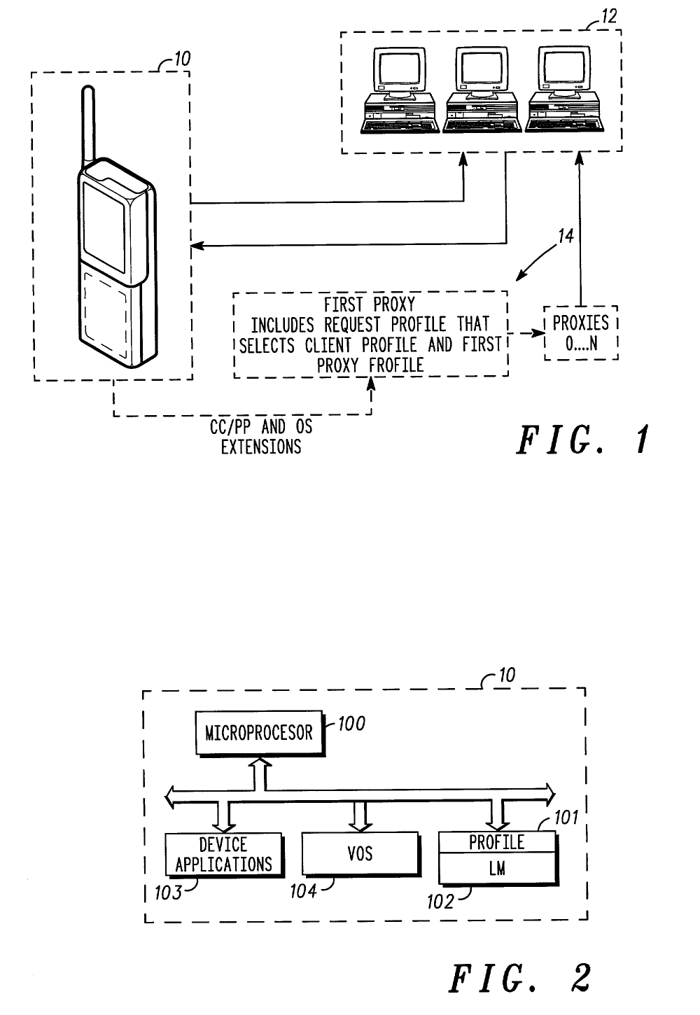

Referring now to the drawings in which like numeral reference like parts, FIG. 1 shows an exemplary environment in which the present invention is implemented. The environment includes a mobile device 10, a sharable resource computer network (sharable network) 12 and intermediate proxy nodes 14. The mobile device 10, intermediate proxy nodes or proxies 14, and the sharable network 12 will be more fully discussed below.

Referring to FIG. 2, the mobile device 10 includes processing means 100 such as a microprocessor, a mobile device type specification (mobile device profile) 101 stored in a mobile device local memory 102, one or more mobile device application programs (application) 103 and a virtual operating system 104 that serves as an interface between the mobile device applications 103 and proxy elements of the intermediate proxy nodes 14 and thus sharable network 12. The elements of the mobile device 10 will be discussed more specifically below.

Referring to FIG. 3-FIG. 6, the mobile device profile 101 provides an information model for describing the capabilities of the mobile device 10 that permits the user of the mobile device 10 to set device preferences. The mobile device profile 101 is structured according to a World Wide Web Consortium Composite Capability/Personal Preferences (W3C-CC/PP) document and is encoded in a resource description framework (RDF) language within an extensible mark up language (XML format). The mobile device profile 101 includes a static profile 105 and as will be further discussed what may be considered a dynamic profile 106. The static profile 105 includes profile components and attributes of the mobile device 10 that rarely change such as, for example, the terminal hardware components. An exemplary device profile 105 is shown in FIG. 3. The exemplary static profile 105 is encoded in RDF/XML format and includes a device CC/PP link and various standardized CC/PP specified profile components. The static profile may also be referred to as a client profile. The dynamic profile 106 permits selection of external network resources to be associated with the mobile device 10 via a mobile device application 103 during a device preferences session. An exemplary dynamic profile 106 is shown in FIG. 6 and again in FIG. 7 and will be discussed more specifically below.

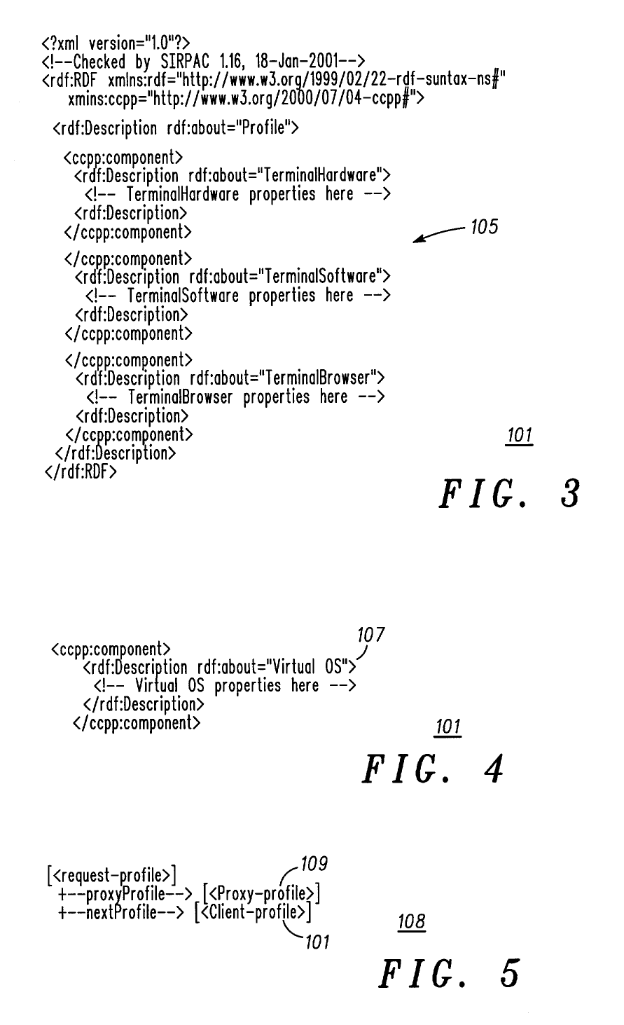

Referring back to FIG. 2, the virtual operating system (VOS) 104 is for supporting augmentation of the mobile device 10. More specifically, the VOS 104 provides communication between the mobile device application 103 and remote proxy elements such as the intermediate proxy nodes 14 or those of the sharable network 12 in a manner transparent to the mobile device user. The VOS 104 includes a virtual operating system profile 107, provided as an extension to the device or client profile 101. The VOS profile 107 includes a VOS application program interface (API), a VOS service type, a VOS service identifier and a related sharable network resource type (discussed below). The VOS profile 107 also includes the VOS version level and the desired device augmentation capabilities. An exemplary VOS profile in XML/RDF format is shown in FIG. 4, as an extension to the client or device profile 101 and more specifically static profile 105. The specific VOS properties are not shown.

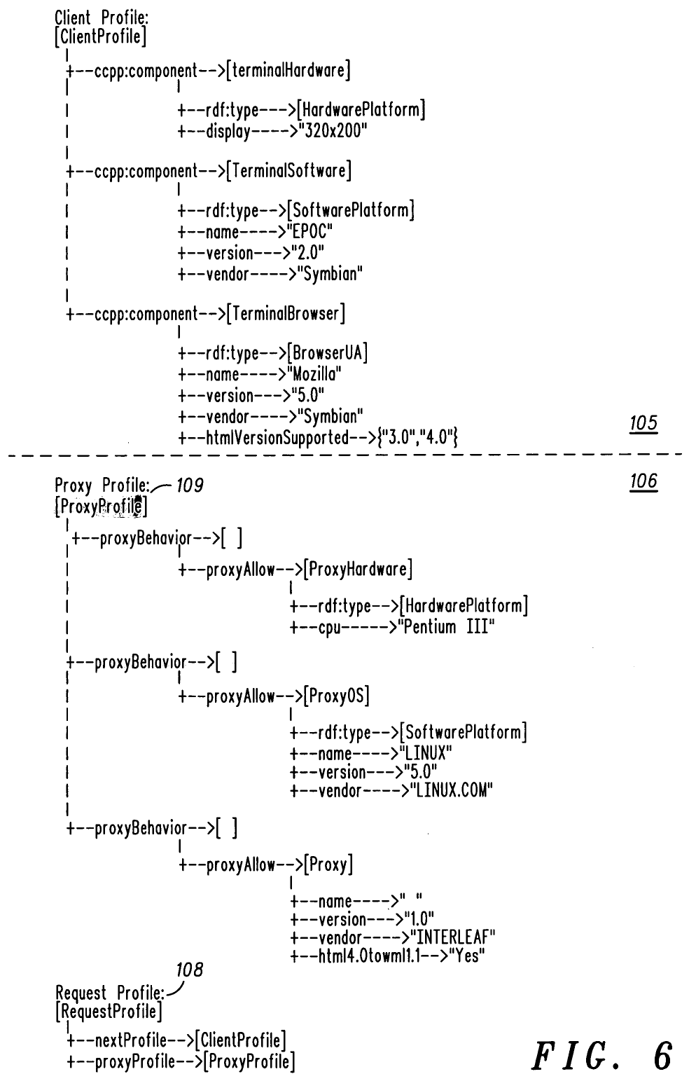

The dynamic profile 106 corresponding to the mobile device includes a request profile 108 (FIG. 5). The request profile 108 includes a linkage between the client profile 101 or static portion thereof and a profile of a proxy (proxy profile) 109, such as intermediate proxy 14. An exemplary request profile in RDF/XML format for requesting service via an intermediate proxy 14 that enables a modification of content from a server to the application program is shown in FIG. 5. The proxy profile 109 of the request profile 108 describes the capabilities of the intermediate proxy 14. The intermediate proxy may add capabilities (such as convert data) or impose policy constraints (such as block capabilities) for a mobile device application 103. For example, an intermediate proxy might provide XHTML to WML format conversion or disallow any HTML content that contains JavaScript. The proxy profile 109 of the intermediate proxy also includes an indication of the mobile device capabilities to which the corresponding proxy behavior is applicable, an indication of new capabilities provided, and an indication of any capabilities that are blocked.

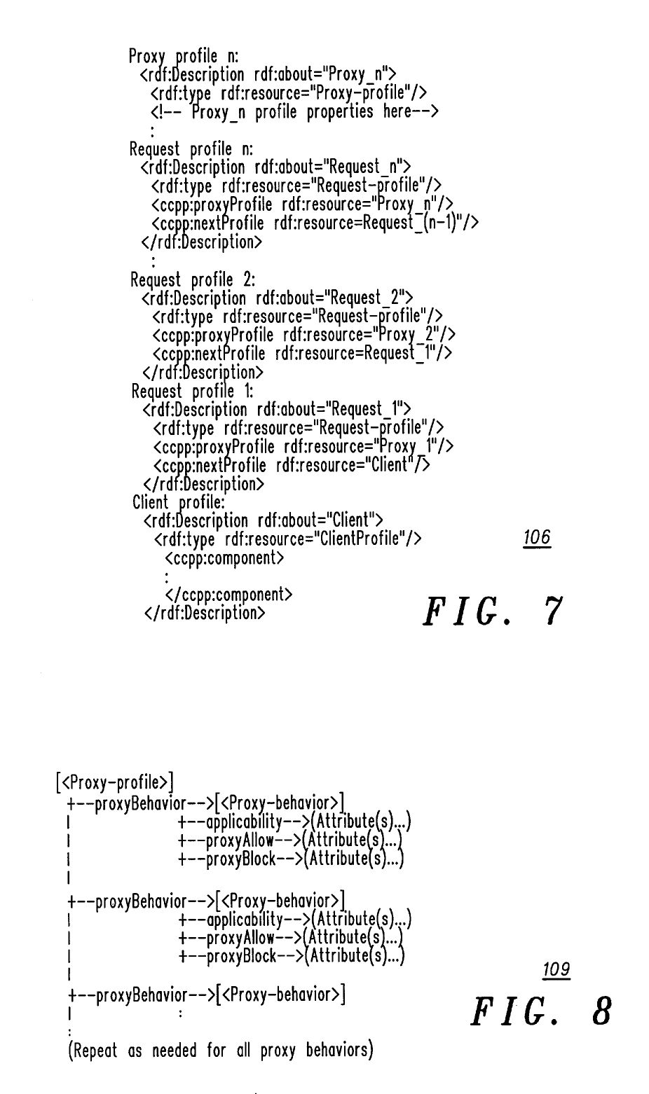

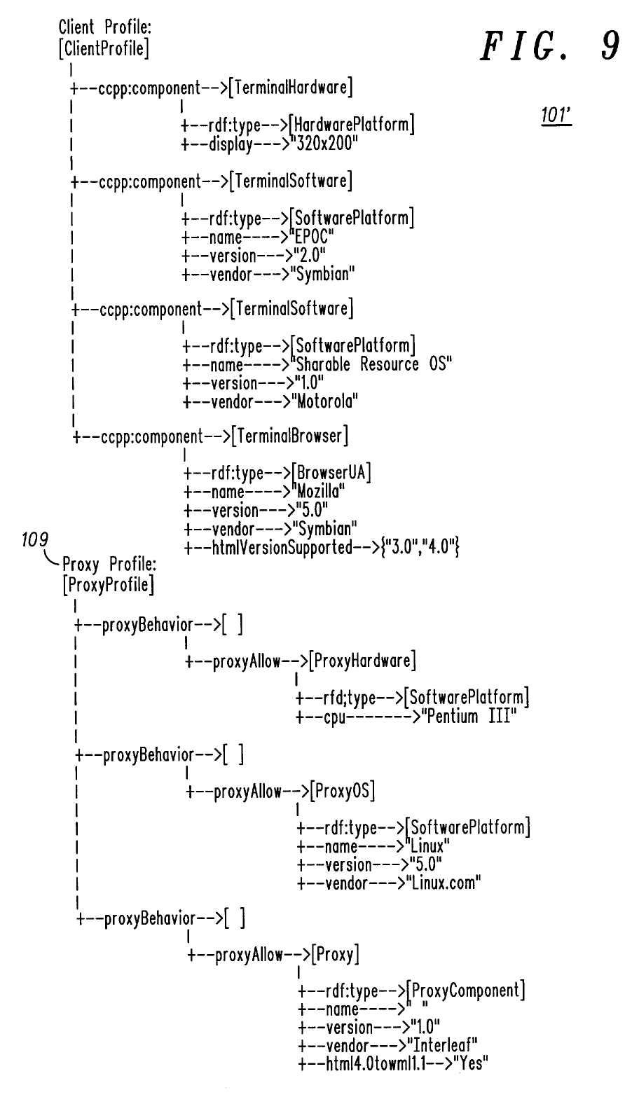

A request profile showing how the client profile and proxy profile are chained together based on the linkage for the request profile that corresponds to the mobile device profile 101, specifically static profile 105 and dynamic profile 106 are shown in FIG. 6. Here the client profile corresponds to the static profile 105 while the proxy profile 109 and the request profile linkage 108 between the two corresponds to the dynamic or changing profile 106. A specific exemplary proxy profile 109 format depicting multiple proxy behaviours is shown in FIG. 8. The request profile 108 is not limited to one intermediate proxy. A mobile device application 103 may request services from multiple intermediate proxies. FIG. 7 shows an exemplary profile corresponding to the mobile device dynamic profile 106 that includes multiple request profile linkages, one for each of n proxies, in XML format.

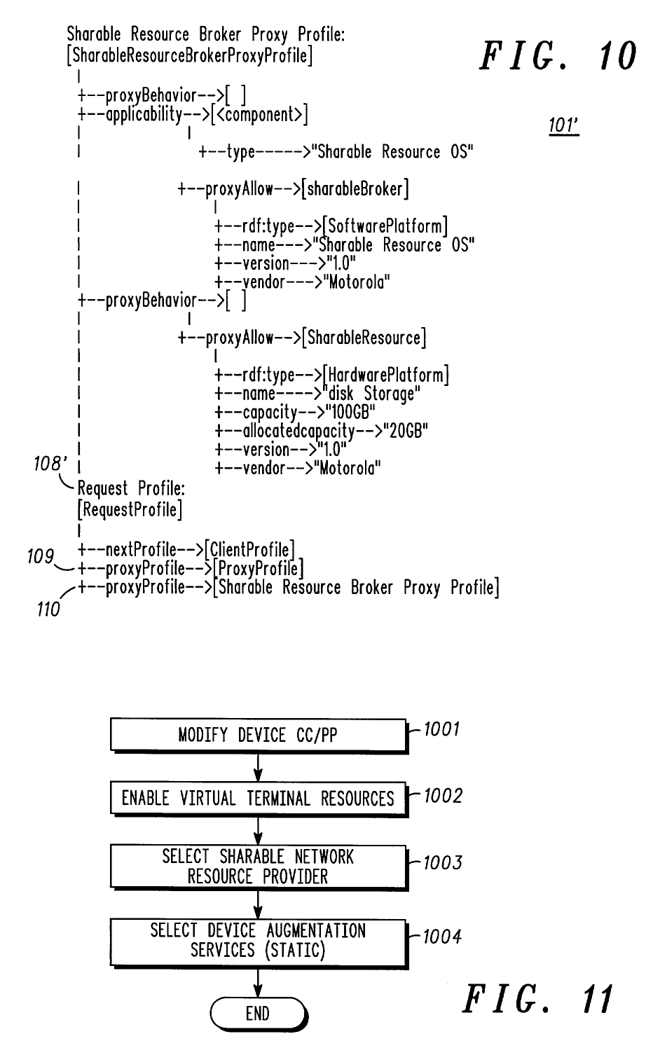

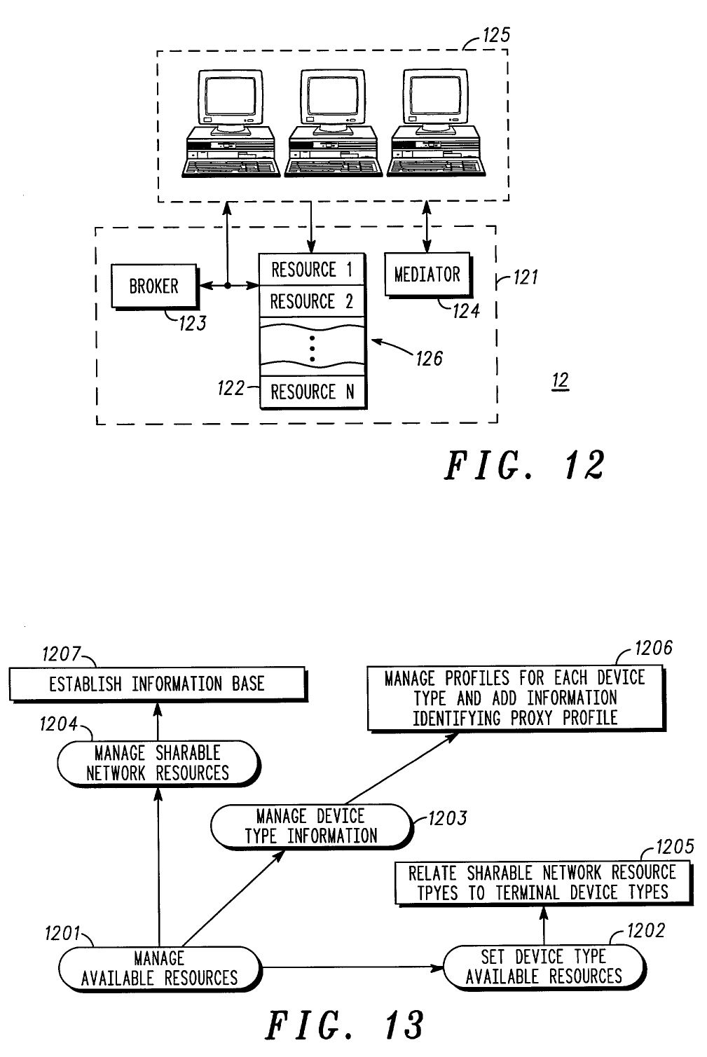

In FIG. 10, an exemplary request profile 108′ for requesting service from the sharable network 12 via a sharable resource broker proxy 123 (discussed below with reference to the sharable resource computer network) is shown. The exemplary request profile 108′ includes a sharable resource broker proxy profile (sharable resource profile) 110 in addition to the intermediate proxy profile 109 and client profile. The sharable resource profile 110 includes similar attributes as the proxy profile 109 and can be communicated in a similar format. As can be seen from FIG. 9 and FIG. 10, the profile 101′ corresponding to a modified mobile device profile includes the client profile chained or linked together with the proxy profile 109 and sharable resource profile 110.

Referring to FIG. 11, operation of the mobile device 10 will be discused. Initially, a selection is made to modify the CC/PP file (mobile device profile) 101 stored in the mobile device local memory 102. The selection is made either by a mobile device user or the mobile device application 103. A user identification and authentication procedure (not shown) may optionally occur at this point due to the importance of this information. At 1001 the mobile device application 103 modifies the CC/PP file by interacting with the mobile device user or by contacting a network. More specifically, at 1001 the CC/PP file is evaluated to determine the capabilities of the mobile device 10. The sharable network 12 provides a set of information choices based on the availability of sharable network resources and the capabilities of the mobile device 10.

At 1002 the user or the mobile device application 103 selects sharable network resources from the set of information choices to be available during any active session by referencing an API for each sharable network resource. The selected specific sharable resources are stored in the VOS profile 107 as related sharable network resource types.

At 1003 the user or the mobile device application 103 selects a sharable network resource provider provided by the VOS 104 if there is no default sharable network resource provider. The sharable network resource provider can be selected from a remote web browser, from a mobile device web browser (not shown) directly, or from a mobile device service menu (not shown) with a preset choice made available from the communications service provider.

At 1004 the user or the mobile device application 103 selects a desired device augmentation service from those presented by the selected sharable network resource provider. The actual augmentation services available will be offered to the mobile device 10 in an appropriate format. For example, the services may be available via a web browser on a computer with visual display, audio, or text selection on the mobile device 12. Augmentation services are repeatedly presented to the mobile device 10 until the session is terminated. Only available sharable network resources for the specific mobile device profile 101 are presented. In addition the system may offer other services to enhance the normal adaptive service response to a user device such as content reformatting.

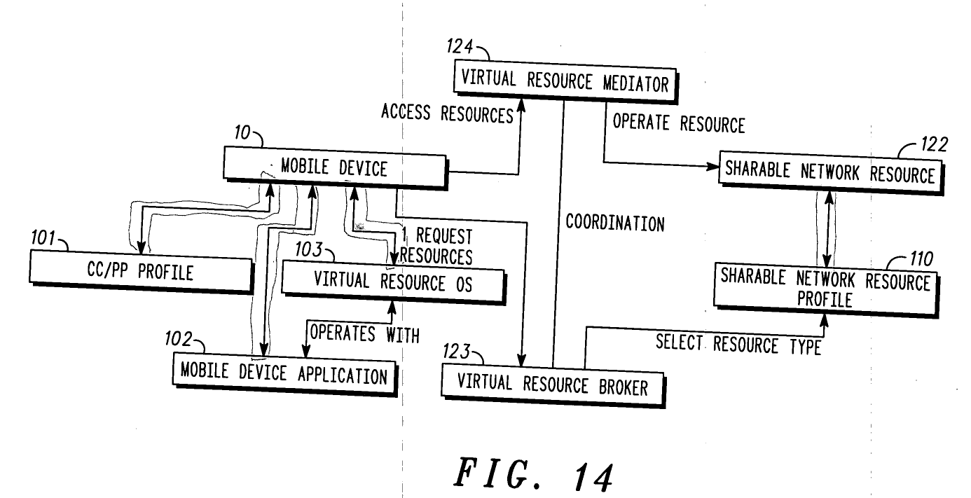

Referring to FIG. 12, the sharable network 12 will be more specifically described. The sharable network 12 includes a virtual network service resource provider 121 and at least one and preferably a plurality of sharable resources 122 identified by a knowledge base 126. The sharable network 12 may be, for example, a plurality of servers or computer hosts 125 at which the knowledge base 126 is stored. The sharable resources 122 may be, for example, persistent storage, host processors, display adaptation, input event adaptation and media adaptation. Each of the sharable resources 122 has a shared network resource profile and an API stored in the knowledge base 126 that can be used by the virtual network service provider 121 to respond to requests for services from the VOS 104.

The virtual network service resource provider 121 is an interface on the sharable network 12 for interfacing between the sharable network 12 and the VOS 104 of the mobile device 10 and may be a software or hardware component of the sharable network 12.

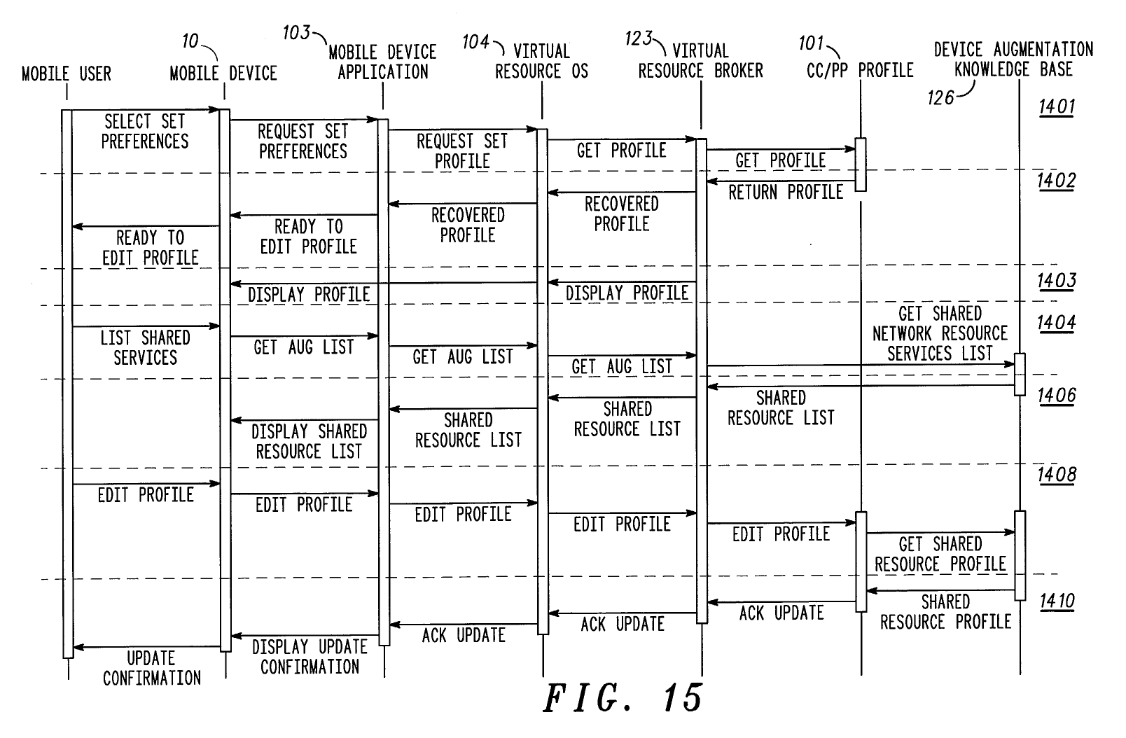

A summary of the functions of the virtual network service provider 121 is shown in FIG. 13. The primary function of the virtual network service provider is to manage the available resources 1201. This primary function involves authenticating the mobile device virtual operating system 104 before granting access to the sharable network 12. The three major functions associated with managing the available resources include setting the available resource for a device type 1202, managing the device type information 1203 and managing the sharable network resources 1204.

The setting the device type available resources function 1202 involves relating the sharable network resource APIs to the mobile device profiles and the augmentation specifically selected (see 1207).

The managing the device type information function 1203 involves managing the mobile device profiles 101 for each mobile device 10 that is supported by the sharable network 12 and populating appropriate information into the CC/PP file of the mobile device profile 101 for identifying various proxy profiles related to a selected sharable network resource (see 1206).

The managing the sharable network resources function 1204 involves establishing the knowledge base that identifies the sharable resources 122 that can augment the mobile device 10 based upon an associated mobile device profile 101 (see 1205). Examples of terms within the knowledge base include a resource type list (set of resource types available on the network), a resource type, a resource name, an API Interface specification, maximum capacity of a specific sharable resource and specific sharable resource attributes.

Referring again to FIG. 12, the virtual network service provider 121 includes a virtual broker proxy (broker) 123 and a virtual mediator (mediator) 124 for performing the above-mentioned functions 1201-1207. The broker 123 is for providing an API directory of the available sharable resources and for providing a directory of mobile device capabilities and any extensions defining augmentation capabilities in a format consistent with the CC/PP file by communicating with the knowledge base 126 and further for coordinating with the mobile device application 103 and the VOS 104 to access the directory of the available sharable resources and for coordinating with the VOS 104 to access the specific sharable resources 122 based upon a determined match. The broker 123 also interprets the mobile device profiles 101 (CC/PP file) and utilizes this information to assist in the determination of appropriate sharable resources for augmenting the mobile device 10. The mediator 124 is for coordinating mediation of content delivery in a format consistent with the mobile device CC/PP file through interaction with the VOS 104 and the API of a specific sharable resource, for coordinating a specific server or computer to access, for coordinating any multiple simultaneous use of a sharable resource in any interactions with the mobile device 10 and for coordinating between the broker 123 and the specific server or computer to maintain a sharable resource during a mobile device session. The mediator 124 also provides content adaptation if necessary by specifying an intermediate proxy.

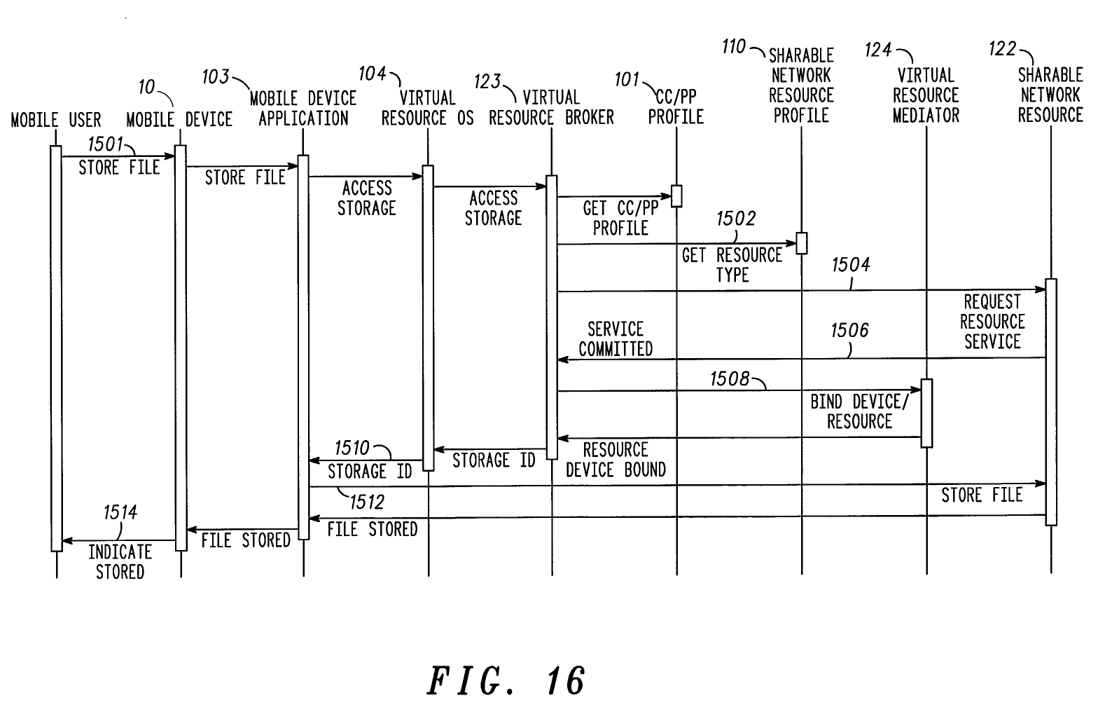

General interaction between the elements of the mobile device 10 and the sharable network 12 will be discussed with primary reference to FIG. 14 and also with reference to FIG. 15. The mobile device profile 101 stored in the device local memory 102 of the mobile device 10 identifies the local resources and application processing capabilities as well as a directory of virtual network resources appropriate for the mobile device type. The mobile device profile 101 preferably includes the CC/PP file. The VOS 104 interfaces with the broker 123 to determine and request sharable network resources from the sharable network 12, interfaces with the mediator 124 to coordinate use of the sharable resources 122 with the local resources of the mobile device 10, coordinates mobile device access to a server at the sharable resources network 12 and coordinates adaptation of the sharable network resources with the application processing capabilities of the mobile device 10. The VOS 104 communicates the mobile device profile (CC/PP profile) 101 to the broker 123 and stores binding information including a time period in which the sharable network resources are used by the mobile device 10. The mobile device 10 also includes a mobile device application 103.

The broker 123 determines available sharable resources 122 of the sharable network 12, determines the application processing capabilities of the mobile device 10 by reading the mobile device or CC/PP profile 101, and matches desired device augmentation with the sharable resources by, for example, comparing a profile of the desired device augmentation (sharable resource profile) 110 with the profile of each available sharable resource 122 (see FIG. 9). The broker 123 also negotiates between the sharable network 12 and the VOS 104 of the mobile device 10 for the available sharable network resources and coordinates the application processing capabilities of the mobile device 10 with the available sharable resources 122. The mediator 124 adapts the available sharable network resources with the application processing capabilities of the mobile device 10, coordinates access between a server of the sharable network 12 and the mobile device 10 for maintaining access during user sessions and binds the available sharable network resources 12 with the mobile device 10 for a specific time duration. Each of the sharable resources 122 has an API in the sharable resource profile 110 that is encoded in a RDF/XML file.

Referring to FIG. 14, in operation, subsequent to having selected a sharable resource network provider, (see 1003 in FIG. 10) the mobile device application 103 requests device augmentation via the VOS 104. Rather than requesting device augmentation generally, the mobile device application 103 may specify an API for a specific sharable resource. The VOS 104 communicates the request along with the CC/PP profile 101 to the broker 123. The request may pass through one or more intermediate proxies before arriving at the broker 123. The request profile 108 includes a proxy profile 109 of each intermediate proxy and a sharable resource profile 110 of the sharable resource corresponding to the requested device augmentation. The broker 123 determines if the sharable resource is available by comparing the API of the specific sharable resource profile 110 with an API directory of sharable resource profiles. Subsequently, the broker 123 negotiates with the VOS 104 for access to the requested sharable resource. Negotiation may involve determining authorization to utilize available sharable resources. Subsequently, the mediator 124 provides access to the sharable resource by coordinating between the broker 123 and server 125 to bind the sharable resource 122 to the mobile device 10 during the user session. The mediator 124 also provides coordinated access if the mobile device 10 has requested multiple sharable resources 122 for simultaneous use. If needed, the mediator 124 can provide content adaptation by specifying an intermediate proxy 14.

Referring to FIG. 15, specific interaction between the elements of the mobile device 10 and the sharable network 12 while setting device preferences will be discussed. Initially, at 1401, the mobile device user indicates to the mobile device 10 a desire to set preferences. The mobile device 10 communicates the set preference request via the mobile device application 103 to the VOS 104. The VOS 104 forwards a get profile request to the broker 123. The broker 123 obtains the CC/PP profile 101 for the specific mobile device 10 and, at 1402, forwards it to the VOS 104. At 1403, the VOS 104 sends a recovered profile signal to the user via mobile device application 103 and the mobile device 10, which subsequently displays the CC/PP profile 101. At 1404, the mobile device user indicates to the mobile device 10 a request for the directory of sharable resources. The mobile device 10 communicates the request via the mobile device application 103, the VOS 104 and the broker 123 to the knowledge base 126. At 1406, the broker 123 obtains the directory of sharable resources from the knowledge base 126 and forwards it to the user, via the VOS 104, the mobile device application 103 and the mobile device 10. At 1408, the user edits the CC/PP profile 101 based upon the directory of sharable resource from the knowledge base 126 and the edited CC/PP profile 101 is forwarded thereto via the mobile device 10, the mobile device application 103, the VOS 104 and the broker 123. At 1410, the broker 123 forwards an acknowledgement signal to the mobile device user via the VOS 104, the mobile device application 103 and the mobile device 10.

Referring to FIG. 16, specific interaction between the elements of the mobile device 10 and the sharable network 12 when file storage is requested as a sharable resource will be discussed. Initially, the mobile user attempts to store a file in the mobile device local memory 102. However, the mobile device 10 lacks sufficient memory for proper storage. At 1501 the mobile device application 103 indicates to the VOS 104, which indicates to the broker 123 a desire to access shared storage resource for the mobile device 10. The broker 123 obtains the CC/PP profile 101. At 1502, the broker 123 obtains the profile of the shared resources 122 from the knowledge base 126 to ascertain service capability. At 1504, the broker 123 requests a sharable resource 122 from the sharable network 12 to bind a new session to the mobile device 10. At 1506, the sharable network 12 commits the service to the broker 123. At 1508, the broker 123 indicates to the mediator 124 success of shared resource and an identification of the shared resource 122 and mobile device 10. The mediator 124 subsequently binds the sharable resource 122 to the mobile device 10 for the duration of the user session. At 1510, the mediator 124 responds to the mobile device application 103 with the storage identification. At 1512, the mobile device application 103 commands a shared storage resource to save the file and transfers the file to storage resource. At 1514, success of file stored is indicated to mobile user via the mobile device application.

Therefore, the present invention provides a sharable network 12 with sharable resources 122 that can dynamically augment the capabilities of the mobile device 10. For example, when a file is sent to a mobile device 10 in a specific format, such as MP3, the sharable network broker 123 determines if the mobile device 10 has capabilities for properly processing the MP3 file and determines if the sharable network 12 has a sharable resource for processing MP3 files. If the broker 123 determines that the sharable network 12 has a sharable resource for properly processing the MP3 file and that the mobile device 10 does not have the capabilities, the mobile device 10 utilizes the capabilities of the sharable network 12 to process the MP3 file.

The present invention also provides a knowledge base 126, such as an RDF/XML knowledge base, in which an application program interface identifies the sharable network 12 and the sharable resources 122. Application programs, such as the device application 103 can be encoded in accordance with this knowledge base 126 that specifies an API for a specific sharable resource 122. As a result, the capabilities of the mobile device 10 are dynamically augmented by the device application 103.

The sharable network 12 of the present invention has the advantage of permitting an intermediate proxy 14, such as a transcoding proxy, to advertise additional capabilities it may have on behalf of its clients. For example, a transcoding proxy may be able to convert HTML to WML. The RDF/XML format of the knowledge base 126 in the sharable network provides a methodology for the transcoding proxy to describe its own capabilities as part of the CC/PP profile communicated to the broker 123.

While the above description is of the preferred embodiment of the present invention, it should be appreciated that the invention may be modified, altered, or varied without deviating from the scope and fair meaning of the following claims.

1. A method for augmenting resources of a mobile device comprising:
maintaining a mobile device type profile for identifying local resources and mobile device application processing capabilities;
interfacing with a sharable network resources broker for determining sharable network resources of a sharable resources network;
requesting specific sharable network resources; and
interfacing with a sharable network resources mediator for coordinating use of the specific sharable network resources with the mobile device local resources and for adapting the specific sharable network resources to the mobile device application processing capabilities.

2. The method of claim 1, wherein the maintaining a mobile device type profile for identifying local resources and mobile device application processing capabilities further comprises maintaining a profile of virtual network resources appropriate for a mobile device type.

3. The method of claim 2, wherein the interfacing with a sharable network resources broker for determining sharable network resources of a sharable resources network further comprises communicating the mobile device type profile to the sharable network resources broker.

4. The method of claim 3, wherein the interfacing with a sharable network resources mediator for coordinating use of the specific sharable network resources with the mobile device local resources and for adapting the specific sharable network resources with the mobile device application processing capabilities further comprises interfacing with the sharable network resources mediator for coordinating mobile device access to a server at the sharable resources network.

5. The method of claim 1, further comprising storing binding information for a time period in which the specific sharable network resources are used by the mobile device.

6. A method for augmenting the resources of a mobile device type comprising:
determining available sharable network resources of a sharable resources network;
determining mobile device application processing capabilities;
coordinating the mobile device application processing capabilities with the available sharable network resources;
negotiating with the mobile device for the available sharable network resources; and
adapting the available sharable network resources with the application processing capabilities of the mobile device.

7. The method of claim 6, wherein the determining mobile device application processing capabilities and the coordinating the mobile device application processing capabilities with the available sharable network resources of the sharable resources network further comprises comparing an application program interface identifying the mobile device application processing capabilities with an application program interface identifying each of the available network resources of the sharable resources network.

8. The method of claim 6, further comprising coordinating access between a server of the sharable resource network and the mobile device for maintaining access to sharable network resources during a user session.

9. The method of claim 6, wherein the determining mobile device application processing capabilities and the coordinating the mobile device application processing capabilities with the available sharable network resources of the sharable resource network further comprises providing access to a resource description framework identifying each of the available sharable network resources of the sharable resources network.

10. A method of augmenting the resources of a mobile device comprising:
receiving a file in a specific format;
determining that mobile device capabilities cannot properly processing the specific format of the file;
determining that a sharable resources network has capabilities for properly processing the specific format of the file;
utilizing the capabilities of the sharable resource network to process the specific format of the file; and
permitting the mobile device access to the processed file.

11. A sharable resource network that augments the resources of a mobile device comprising:
means for determining available sharable network resources;
means for determining mobile device application processing capabilities;
means for coordinating the mobile device application processing capabilities with the available sharable network resources;
means for negotiating with the mobile device for mobile device access to the network resources;
means for adapting the available sharable network resources with the application processing capabilities of the mobile device; and
means for binding the available sharable network resources with the mobile device for a specific time duration.

12. The sharable resource network of claim 11, wherein the means for determining mobile device application processing capabilities and the means for coordinating the mobile device application processing capabilities with the available sharable network resources of the sharable resources network further comprises means for comparing an application program interface identifying the mobile device application processing capabilities with an application program interface identifying each of the available sharable network resources and the means for binding the available sharable network resources with the mobile device further including binding the available sharable network resources for a duration of mobile device use of the sharable network resources.

13. The sharable resource network of claim 11, further comprising means for coordinating access between a sharable resources network server and the mobile device for maintaining access to sharable network resources during a user session.

14. The sharable resource network of claim 11, wherein the means for determining mobile device application processing capabilities and the means for coordinating the mobile device application processing capabilities with the available sharable network resources further comprises means for comparing a resource description framework identifying the mobile device application processing capabilities with a resource description framework identifying each of the available sharable network resources.

15. A mobile device with dynamic resource capabilities comprising:
a mobile device profile stored in a mobile device local memory for identifying local resources and application processing capabilities;
a virtual interface for interfacing with a sharable resources network broker for determining sharable network resources of a sharable resources network;
wherein the virtual interface further is for requesting sharable network resources and interfacing with a sharable resource network mediator for coordinating the sharable network resources with the local resources of the mobile device and for adapting the sharable network resources with the application processing capabilities of the mobile device.

16. The mobile device of claim 15, further comprising a profile of virtual network resources appropriate for the mobile device stored in the mobile device local memory.

17. The mobile device of claim 16, wherein the virtual interface is further for communicating the mobile device profile to the sharable resource network broker.

18. The mobile device of claim 17, wherein the virtual interface is further for interfacing with the sharable resource network for coordinating mobile device access to a specific server at the communication network.

19. The mobile device of claim 15, wherein the virtual interface is further for storing binding information in the mobile device local memory, wherein the binding information includes a time period in which the sharable network resources are used by the mobile device and the location of the sharable network resource.

20. A system for providing augmented resource capability comprising:
a mobile device that includes a composite capability personal preferences file describing the mobile device capabilities, a device application program and a virtual operating system; and
a sharable resource computer network that includes one or more computer servers, one or more sharable resources, a knowledge base that specifies an application program interface for each of the one or more sharable resources, a network broker in communication with the mobile device for receiving requests for sharable network resources and for negotiating the requests,
wherein the sharable resource network broker is further for modifying the composite capability/personal preferences file to include reference to an application program interface of one or more sharable resources.

21. The system of claim 20, wherein the device application program specifies one or more application program interfaces of the knowledge base for dynamically augmenting the capabilities of the mobile device.

22. A method of providing dynamic mobile device augmentation comprising:
evaluating the format of a file destined for a mobile device;
comparing the format of the file with a composite capability/personal preferences file describing the application processing capabilities of the mobile device; and
dynamically allocating sharable resources to the mobile device if the mobile device lacks the application processing capabilities for processing the file.
